(19) United States
(12) Patent Application Publication
(10) Pub. No.: US 2005/0094669 A1
(43) Pub. Date: May 5, 2005

(54) Virtual concatenation receiver processing with memory addressing scheme to avoid delays at address scatter points

(76) Inventor: Sanjay Bhardwaj, Fremont, CA (US)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 10/697,414

(22) Filed: Oct. 30, 2003

(51) Int. Cl. H04J 3/00

(52) U.S. Cl. 370/476

(57) ABSTRACT

In processing received virtual concatenation frames, the memory write address can be appropriately controlled to force bank switches where address scattering occurs. Arbitrary identifiers assigned to the arriving frames and the subcolumns thereof are used instead of H4 information to calculate the memory write addresses.

### FIELD OF THE INVENTION

The invention relates generally to data processing and, more particularly, to the use of memory in data processing.

### BACKGROUND OF THE INVENTION

SONET/SDH is a conventional standard for optical transport of payloads over both long haul and short haul networks. The frame structure and multiplexing techniques lend themselves to the type of constant rate traffic that is prevalent in voice and TDM applications. Virtual concatenation (VC) is a conventional technique for breaking a contiguous payload at the path level into smaller synchronous payload envelopes (SPEs). The SPEs are sent over the network as individual separate entities. At the receiving end, these separate entities are gathered and realigned into a contiguous payload. A virtually concatenated link can be, for example, a group of STS1's and/or STS3's arranged such that the combination of their individual SPE's forms a contiguous payload.

The segmentation and reassembly associated with virtual concatenation requires relatively complex logic at both the transmitting end and the receiving end. For example, the receiving end must be able to detect, from the H4 byte information in the path overhead (POH) portion of each SPE, the temporal order of the frames and also the temporal order of the STS1s/STS3s within a frame. To support an exemplary jitter of 12 ms for a 10 Gb OC 192 link, about 100 frames could be outstanding between the transmit end and the receiving end at any time. In conventional systems, the receiving end stores the frames in memory, and eventually reads the frames from the memory in the same order and with the same data arrangement as the frames were originally transmitted at the transmitting end.

A standard STS1 unit in a SONET system is composed of 9 rows and 90 columns. 3 of the 90 columns are section and line overhead which do not participate in path level concatenation. The remaining 9 row by 87 column entity is the synchronous payload envelope or SPE. A typical SONET frame assembled at the transmitting end might include 192 STS1 SPEs, as shown at STS1-1, STS1-2, . . . STS1-192 in FIG. 1. Each of the 192 SPEs is also typically referred to as a subcolumn. Thus, the frame of FIG. 1 can be thought of as having 192 subcolumns, each subcolumn including 87 columns. The first column of each subcolumn is the path overhead POH column. The 9 row by 576 column portion dedicated to section and line overhead for the 192 subcolumns is designated as TOH (transport overhead) in FIG. 1.

Comparing the transmitted master physical frame of FIG. 1 to the received frame of FIG. 2, it can be seen that the individual subcolumns can arrive at the receiver in any order. (This order, once established, remains fixed over time until reestablishment.) Moreover, conventional pointer processing at the individual subcolumn level can phase shift each individual subcolumn so that the subcolumns may span 2 master physical frames. Each of the 6 subcolumns illustrated in FIG. 2 spans 2 master physical frames, because they each “spill over” into the next master physical frame. The hatched region represents data from subcolumns associated with the previous master physical frame.

As indicated above, conventional systems store the subcolumns of the received frames in memory, and then eventually read out the frames in the same order in which they were transmitted, with the subcolumns of each frame arranged in the same order in which they were packed in the frame at the transmitting end. One conventional approach to storing the incoming data is to calculate a memory byte address for each byte received according to the following equation:
Memory byte Address=150336*frameid+row*16704+subcol*87+col. (Equation 1)
Assuming that, for a given maximum jitter time that is to be supported, X frames could be outstanding in the network between the transmitting end and the receiving end at any time, then in the foregoing memory byte address calculation, frameid spans from 0 to X-1. Also in the foregoing exemplary memory byte address calculation, row spans from 0 to 8, subcol (subcolumn) spans from 0 to 191, and col (column) spans from 0 to 86.

Consider a conventional 64 megabit×32 memory, organized as 4 banks of 512×K 32, with each of the banks organized as 2048 rows by 256 columns by 32 bits. Some conventional VC receivers use two such memories in order to provide the necessary storage capacity. In such an arrangement, each column within each bank holds 8 bytes. With 256 columns in each bank, and using the foregoing memory byte address calculation, a row will be crossed every 2048 bytes (256×8 bytes). Therefore, whenever the respective memory byte addresses calculated for consecutively stored bytes differ from one another by 2048, a row must be crossed within the bank. In conventional DRAM architectures, any row crossing within the same bank incurs a well known row-crossing penalty which disadvantageously delays the ongoing data storage process. Therefore, within any single bank of DRAM, whenever the next byte is stored in a memory location whose memory byte address differs by about 2048 or more from the memory byte address where the previous byte was stored, a row-crossing penalty is incurred.

Referring again to FIG. 2, as the bytes of exemplary row R are sequentially taken from left to right and written into the memory, the calculated memory byte address can change quite dramatically (this change is also referred to herein as “address scattering”) every 87 bytes, namely at the boundaries between adjacent subcolumns. More specifically, every 87 bytes, subcol can change by as much as 191, row can change by as much as 8, and frameid can, for a 12 ms jitter parameter, change by as much as 99. Clearly then, at the subcolumn boundaries, there is a significant possibility that the currently calculated memory byte address will differ from the immediately preceding memory byte address by 2048 or more. Therefore, the aforementioned row-crossing delay can be expected to be incurred at many of the subcolumn boundaries.

As mentioned above, the H4 byte in the POH column of each subcolumn is conventionally used to identify uniquely the subcolumn, and also the frame in which the subcolumn was packed at the transmitter. However, each H4 byte is located in the fourth row of its subcolumn, so the foregoing memory byte address calculation cannot be performed for any of the bytes of a given subcolumn until the H4 byte (and consequently approximately half of the frame) has been received. At that point, the H4 byte can be examined to determine the value of frameid and subcol for the memory byte address calculation. Some conventional VC receivers therefore buffer the subcolumns until their H4 bytes become available, at which time the memory storage operation can begin.

It is desirable in view of the foregoing to provide for receiving and storing virtual concatenation frames with reduced risk of incurring row-crossing penalties, and without the need to buffer the data before storing it.

### SUMMARY OF THE INVENTION

According to exemplary embodiments of the invention, the memory write address can be appropriately controlled to force bank switches where address scattering occurs. Arbitrary identifiers assigned to the arriving frames and subcolumns are used instead of H4 information to calculate the memory write addresses.

### BRIEF DESCRIPTION OF THE DRAWINGS

FIG. 1 illustrates a transmit-side example of a SONET frame that employs virtual concatenation.

FIG. 2 illustrates an example of how the transmit-side frame of FIG. 1 may arrive at the receiver.

FIG. 3 diagrammatically illustrates exemplary embodiments of a virtual concatenation receiver according to the invention.

FIG. 4 diagrammatically illustrates exemplary embodiments of a write address input generator according to the invention that can be utilized in the memory interface of FIG. 3.

FIG. 5 diagrammatically illustrates how the write address input values of FIG. 4 can be used according to exemplary embodiments of the invention to drive an address calculator and memory controller within the memory interface of FIG. 3.

FIG. 6 illustrates exemplary operations which can be performed by the write address input generator of FIG. 4.

FIG. 7 diagrammatically illustrates exemplary embodiments of an address input controller according to the invention which can be used in the memory interface of FIG. 3 to drive the address calculator and memory controller of FIG. 5.

FIG. 8 diagrammatically illustrates how the write address input values of FIG. 4 can be used according to exemplary embodiments of the invention to force bank switching at address scattering points.

FIG. 9 diagrammatically illustrates further exemplary embodiments of the memory interface of FIG. 3 according to the invention.

### DETAILED DESCRIPTION

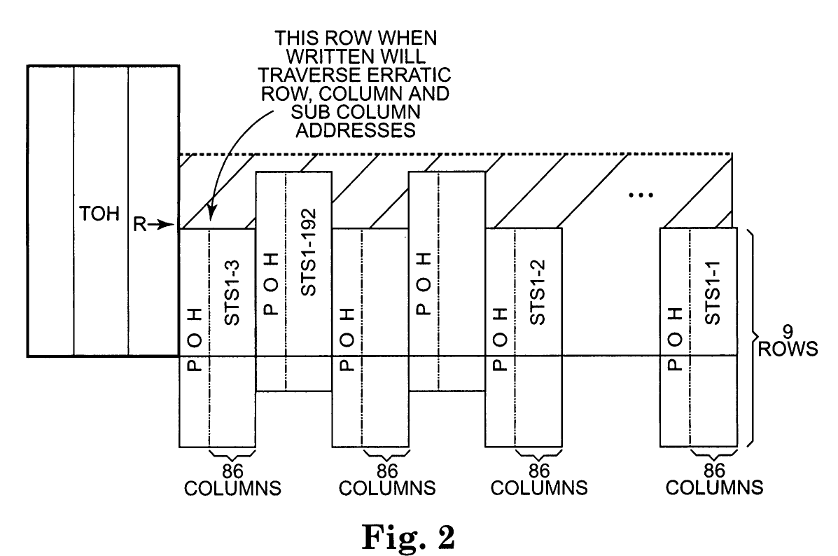

Exemplary embodiments of the invention exploit the fact that some DRAM architectures will permit row-crossing without the aforementioned penalty if the rows involved are in different banks of the DRAM architecture. According to exemplary embodiments of the invention, the write address is appropriately controlled to force a bank switch where address scattering occurs (e.g., at subcolumn boundaries). Referring again to row R of FIG. 2, the first 87 bytes of row R can be stored in a first bank, the next 87 bytes of row R can be stored in a second bank other than the first bank, and the next 87 bytes of row R can be stored in a bank other than the second bank, and so on. By forcing a bank switch at each subcolumn boundary, exemplary embodiments of the present invention can avoid the row-crossing penalty that would otherwise occur due to the above-described address scattering that can occur at the subcolumn boundaries.

Further according to exemplary embodiments of the invention, arbitrary identifiers can be assigned to the arriving frames and subcolumns, and these arbitrary identifiers can be used immediately to calculate memory byte addresses for the incoming data, thereby permitting the incoming data to be stored immediately without intermediate buffering to wait for the actual identifiers. When the associated H4 byte arrives to make the actual frame and subcolumn identifiers available, these actual identifiers are associated with the corresponding arbitrary identifiers that have already been assigned, thereby permitting translation from the actual identifiers to the arbitrary identifiers then the data is read back out of the memory.

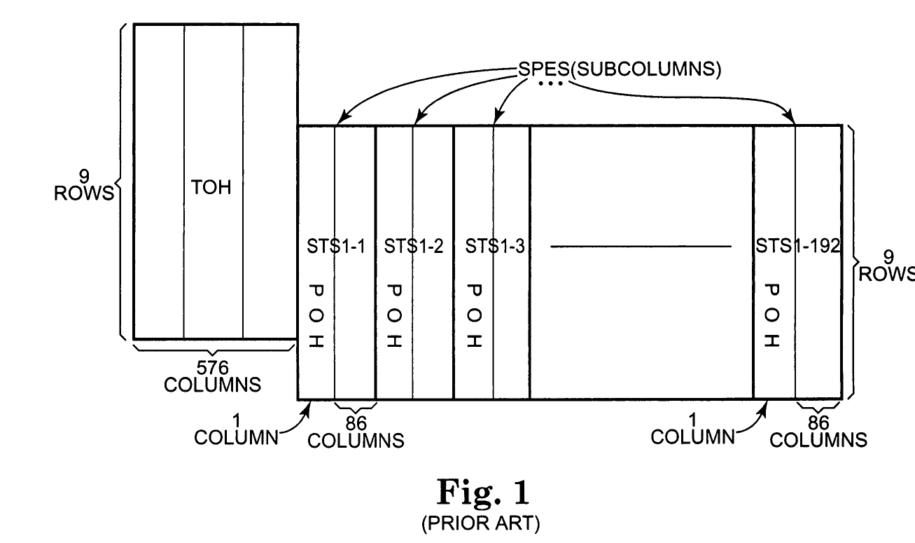

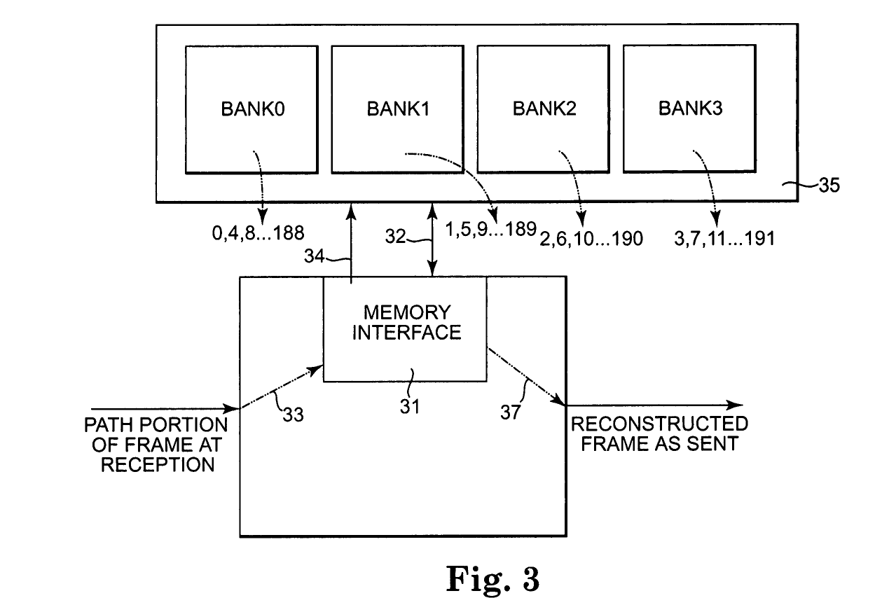

FIG. 3 diagrammatically illustrates exemplary embodiments of a VC receiver according to the invention. The VC receiver of FIG. 3 includes a memory interface 31 that receives at 33 the incoming VC frames (see, e.g., FIG. 2) from the network. The memory interface 31 writes the incoming data into a multi-bank memory 35, and thereafter reads the data out of the memory 35. These memory writing and reading operations effectuate a reconstruction of the received data such that the memory interface 31 provides at 37 reconstructed frames which are the same as the originally-transmitted frames (see, e.g., FIG. 1). The data transfer path between memory interface 31 and memory 35 is illustrated diagrammatically at 32, and the control and address signals for memory 35 are diagrammatically illustrated at 34. The multi-bank memory 35 can be, for example, any conventional DRAM architecture that does not impose a row-crossing penalty when the different rows involved reside in respectively different banks of the memory. In some embodiments, the memory interface 31 is provided on an integrated circuit chip, and the multi-bank memory 35 is provided off-chip from the memory interface 31.

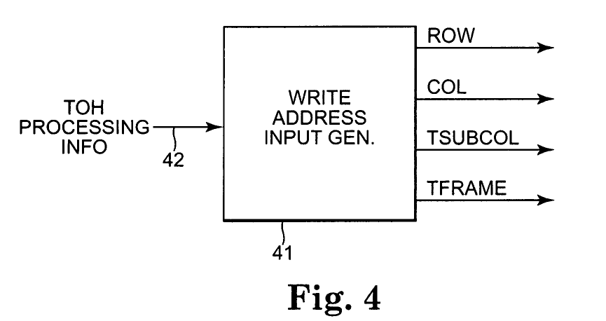

FIG. 4 diagrammatically illustrates exemplary embodiments of a write address input generator 41 which can be provided in the memory interface 31 of FIG. 3. The write address input generator receives at 42 information conventionally available from TOH processing. This conventional TOH processing information indicates when the input data bus 33 of FIG. 3 (e.g., a conventional 16-byte bus) has data for the beginning of a new master physical frame, and also indicates when and where the respective J1 bytes of the subcolumns appear on the input data bus at 33. Each J1 byte is the first byte (row 0, column 0) of its associated subcolumn and, as is well known in the art, all of the bytes of a given subcolumn can be located and identified with respect to the known position of the corresponding J1 byte for that subcolumn.

The write address input generator 41 uses the conventionally available TOH processing information 42 to assign arbitrary identifiers to the incoming frames and subcolumns. In some exemplary embodiments, the arbitrary identifiers are assigned to the frames and subcolumns such that they indicate the temporal order in which the frames and subcolumns arrive at the receiver. Thus, the first frame that arrives can be assigned a temporal frame number of 0, the next frame that arrives can be assigned a temporal frame number of 1, and so on. Each temporal frame number, designated generally as tframe in FIG. 4, can then be used to calculate the memory byte addresses for storing the bytes of its associated frame. Similarly, within a given frame, the write address input generator 41 can assign a temporal subcolumn number of 0 to the subcolumn that arrives first, a temporal subcolumn number of 1 to the subcolumn that arrives second, and so on. Each temporal subcolumn number, designated as tsubcol in FIG. 4, can then be used to calculate the memory byte addresses for storing the bytes of that particular subcolumn. The write address input generator 41 also produces a row number and a column number, respectively designated as row and col in FIG. 4. The values of row and col are also used in the memory byte address calculations (see Equation 1). The values of row and col for a given incoming data byte can simply correspond to the row and column position of that data byte within its subcolumn.

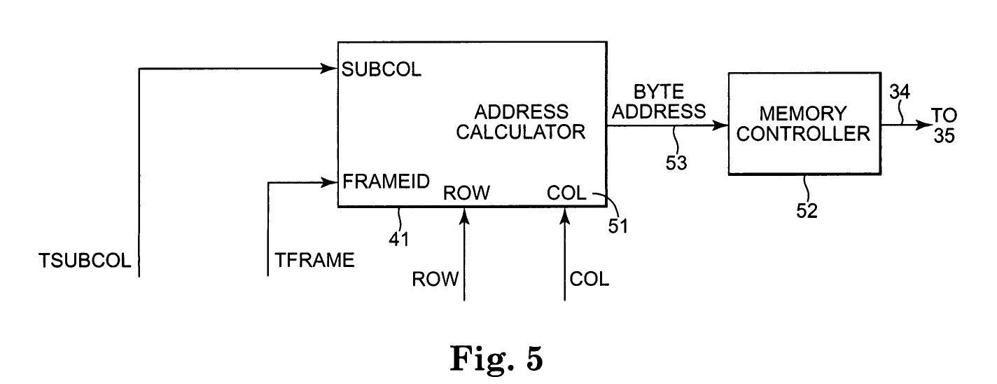

FIG. 5 diagrammatically illustrates an address calculator and memory controller which can be utilized in the memory interface 31 of FIG. 3. The write address inputs produced by the write address input generator 41 of FIG. 4 are provided to the address calculator 51 of FIG. 5. The address calculator 51 can utilize conventional techniques to implement the memory byte address calculation of Equation 1 above. In particular, the temporal subcolumn number tsubcol produced by the generator 41 of FIG. 4 is used as subcol in the address calculation, and the temporal frame number tframe of FIG. 4 is used as frameid in the address calculation. The row and col values of FIG. 4 are used as row and col in the address calculation. The address calculator 51 plugs the inputs received from write address input generator 41 into Equation 1 to produce the memory byte address at 53. This memory byte address is input to a memory controller 52 which can respond thereto in conventional fashion to control access of the multi-bank memory 35 via address and control lines 34 (see also FIG. 3).

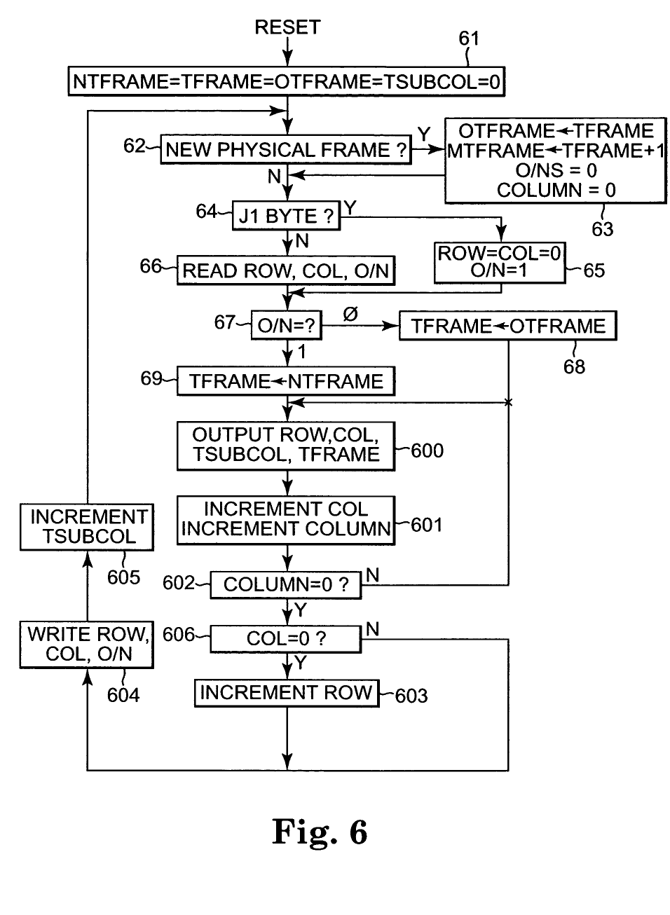

FIG. 6 illustrates exemplary operations which can be performed by the write address input generator 41 of FIG. 4 to produce the input values for the address calculator 51 of FIG. 5. In some embodiments, col increments from 0 through 86 and wraps back around to 0, row increments from 0 through 8 and wraps back around to 0, tsubcol increments from 0 through 191 and wraps back around to 0, and ntframe increments from 0 through 99 and wraps back around to 0.

After initializing variables at 61, it is determined (from TOH processing information) at 62 whether or not a new physical frame has arrived. If so, then at 63 the current temporal frame number, tframe, becomes the old temporal frame number, otframe. Also at 63, tframe is incremented to produce the new temporal frame number, ntframe, and a plurality of old/new flags (designated as O/N), which respectively correspond to the subcolumns, are cleared. Further at 63, a counter variable “column” is cleared to zero. This counter variable “column” is used to track the subcolumn boundaries as the bytes of a given row of the physical frame are received and stored in memory. As such, the variable “column” increments from 0 through 86 and wraps back around to 0. After 63, or if no new physical frame is detected at 62, it is determined at 64 whether a J1 byte has arrived. If so, because the J1 byte is located at row 0, column 0 of its associated subcolumn, the values row and col are set to 0 at 65, and the old/new flag associated with the current value of tsubcol is set. If it is determined at 64 that no J1 byte has arrived, then the old/new flag and the values of row and col associated with the current value of tsubcol are read from memory at 66.

In general, the clearing of all O/N flags at 63 represents an initial assumption that all incoming subcolumn data is associated with the previous (old) frame (see hatched portion of FIG. 2) rather than the new frame that was detected at 62. However, if a J1 byte is detected at 64, then the current subcolumn is part of the new frame so its O/N flag is set at 65 to so indicate, and row and col are cleared at 65 to correspond to the predefined row 0, column 0 location of J1. If no J1 byte is detected at 64, then processing of the current subcolumn must be resumed where it halted previously. So, at 66, the pertinent row and column for the current subcolumn (i.e., corresponding to the current value of tsubcol) are retrieved from storage.

After the appropriate processing has been selected and performed at 65 or 66, the old/new flag is inspected at 67. If the value is 0, then the current subcolumn is part of the previous frame, so tframe takes the value of otframe at 68. Otherwise, if the old/new flag value is 1, then the current subcolumn is part of the most recently received frame, so tframe takes the value of ntframe at 69. After the proper tframe value has been determined at 68 or 69, the values of row, col, tsubcol and tframe (see also FIG. 4) are output at 600. Thereafter at 601, the variables col and “column” are incremented, and the operations at 600 and 601 are repeated until the value of “column” wraps around from 86 to 0, as illustrated at 602. This wraparound of “column” indicates that a subcolumn boundary has been reached in the physical frame. This means that the old/new flag and the values of row and col corresponding to the current value of tsubcol must be stored temporarily (until the current subcolumn is next encountered in the frame). Thus, if col≢0 at 606, then the store operation is performed at 604. If col=0 at 606, then row is incremented at 603 before the store operation at 604. At 605, after the store operation 604, tsubcol is incremented, after which operations return to 62.

In some embodiments, if X frames can be outstanding between the transmitter and the receiver at any time, ntframe can increment from 0 through X−1+j and wrap back around to 0. The extra j values provide extra temporal frame identifiers, which can help avoid aliasing and can also provide room to report jitter violations.

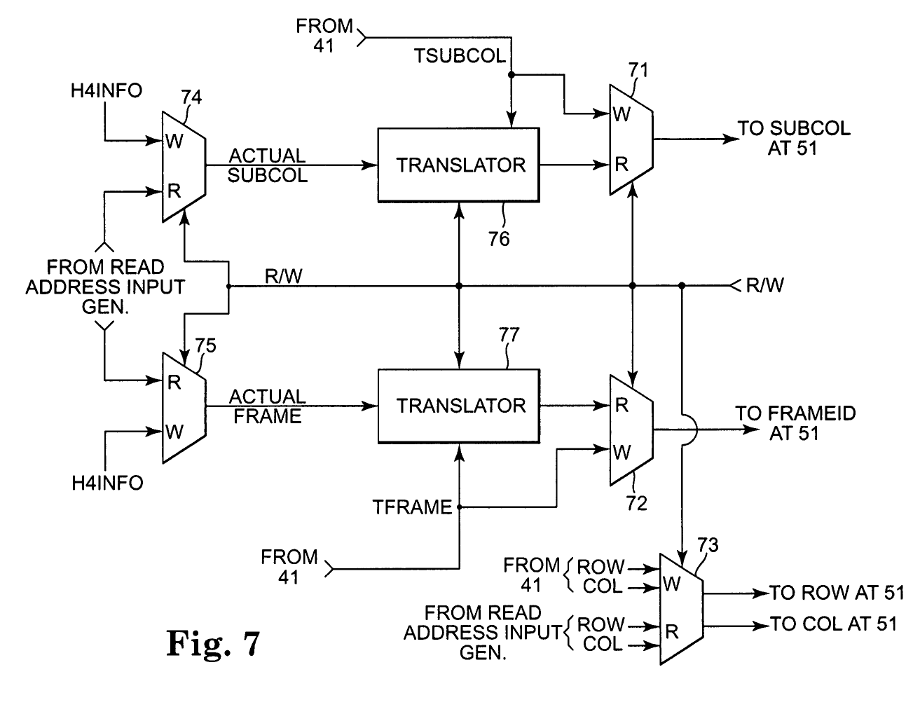

FIG. 7 diagrammatically illustrates exemplary embodiments of an address input controller according to the invention which can be used in memory interface 31 to drive the address calculator and memory controller of FIG. 5. During memory write operations, the read/write signal R/W controls selectors 71, 72 and 73 such that the outputs of the write address input generator 41 of FIG. 4 are applied to the address calculator 51 of FIG. 5. Also during memory write operations, selector 74 is controlled by the R/W signal such that the actual subcolumn identification information contained in the H4 byte of the subcolumn that is currently being written can be input to a translator 76. The translator 76 also receives the temporal subcolumn identifier tsubcol from the write address input generator 41 and, during write operations, is controlled by the R/W signal such that the actual subcolumn identifier from the H4 byte is associated with the temporal subcolumn identifier tsubcol, for example, in a suitable table or other associative data structure. Also during memory write operations, a translator 77 performs an analogous associative operation between the actual frame identifier from the H4 byte (received via selector 75) and the temporal frame identifier tframe received from the write address input generator 41. Thus, during memory write operations, the translators 76 and 77 maintain respective data structures which associate the temporal subcolumn identifiers and the temporal frame identifiers with their corresponding actual subcolumn identifiers and actual frame identifiers as determined by conventional H4 byte processing.

During memory read operations, the selectors 74 and 75 are controlled by the R/W signal such that the actual subcolumn and frame identifiers produced, for example, by a conventional read address input generator, are input to the respective translators 76 and 77. In response to the actual subcolumn identifier, the translator 76 outputs the corresponding temporal subcolumn identifier, which the selector 71 passes through to the address calculator 51. Similarly, in response to the actual frame identifier, the translator 77 outputs the corresponding temporal frame identifier, which the selector 72 passes through to the address calculator 51. Also during memory read operations, the selector 73 can pass to the address calculator 51 row and col values produced by a conventional read address input generator. Thus, the arrangement of FIG. 7 can receive from a conventional read address input generator the actual subcolumn identifiers and actual frame identifiers that would conventionally be applied to the address calculator 51 of FIG. 5 in a conventional VC receiver, and can translate those actual subcolumn identifiers and actual frame identifiers into the corresponding temporal subcolumn identifiers and temporal frame identifiers that were assigned to the corresponding subcolumns and frames by the write address input generator 41. In this fashion, the memory read operation will produce the frames and subcolumns in the order defined by the conventional read address input generator.

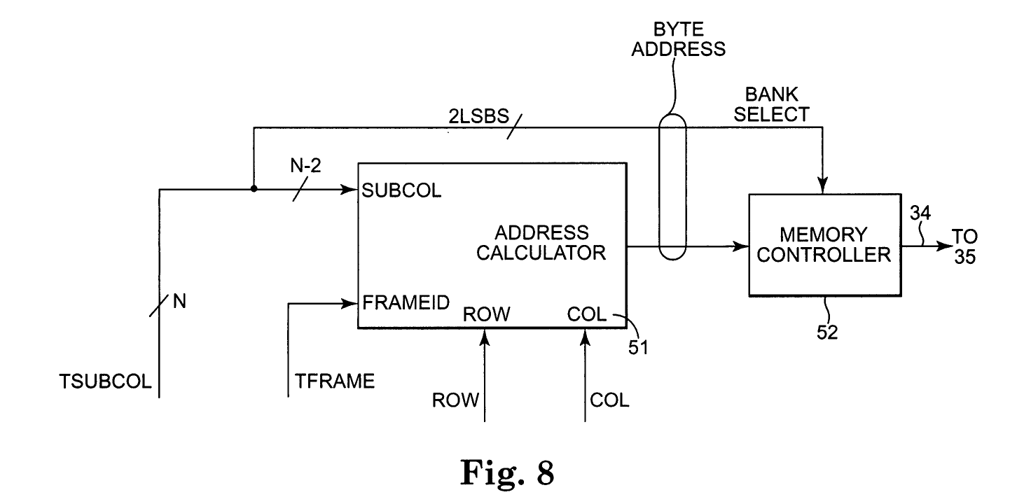

FIG. 8 is similar to FIG. 5, but illustrates how the write address inputs produced by the write address input generator 41 of FIG. 4 (or the translators 76 and 77 of FIG. 7) can be utilized to drive the conventional address calculator 51 and memory controller 52 in a manner such that a bank switch will be forced at each subcolumn boundary. As mentioned above, significant memory address scattering can occur at the subcolumn boundaries as the bytes of the row R of FIG. 2 are written into memory. Because the temporal subcolumn identifier tsubcol can be directly indicative of the order in which the subcolumns have been received, the least significant bits of tsubcol can directly indicate when a subcolumn boundary is reached in row R. Continuing with the example of the memory 35 of FIG. 3, in order to utilize each of the four banks of that memory, the two least significant bits of the temporal subcolumn identifier tsubcol can be utilized as the bank select bits as shown in FIG. 8. Using these two least significant bits for bank selection means that the first, fifth, ninth, etc. subcolumns received (corresponding to tsubcol=0, 4, 8, etc.) will be written to bank 0, the second, sixth, tenth, etc. subcolumns received (corresponding to tsubcol=1, 5, 9, etc.) will be written to bank 1, the third, seventh, eleventh, etc. subcolumns received (corresponding to tsubcol=2, 6, 10, etc.) will be written to bank 2, and the fourth, eighth, twelfth, etc. subcolumns received (corresponding to tsubcol=3, 7, 11, etc.) will be written to bank 3 (see also FIG. 3). The arrangement of FIG. 8 differs from the conventional bank select control wherein, for a 4 bank memory, the two most significant bits of the byte address are used as bank select bits, which is the case in the example of FIG. 5. Rather, in FIG. 8, the bank select bits are driven directly by the two least significant bits of the temporal subcolumn identifier tsubcol. Also, because the two least significant bits of tsubcol have been stripped for use as bank select bits, the subcol input of the address calculator 51 is driven by a twice right-shifted version of tsubcol.

This is mathematically represented as:
Memory Byte Address=150336*frameid+row*16704+(subcol>>2)*87+col (Equation 2)

By using this explicit addressing scheme, the predictability in scattered addressing is exploited and banks are forced to switch, thereby hiding the row crossing penalties as much as possible.

In embodiments such as illustrated in FIG. 8, where bank switches are forced at the subcolumn boundaries, it is possible for the subcolumns of the received frames to be ordered in such a manner that two consecutive values of tsubcol produced by the translator 76 of FIG. 7 will result in two corresponding read accesses from a single bank of the memory 35. For the reasons given in detail above, such consecutive memory accesses from a single bank will often result in a row-crossing penalty. As an example, if the second subcolumn of the transmitted frame arrives as the fifth subcolumn of the received frame, then the operation of the translator 76 of FIG. 7 in conjunction with the memory address calculator of FIG. 8 will result in two consecutive read accesses from memory bank 0 of the memory 35 of FIG. 3. The same result would obtain if the second subcolumn of the transmitted frame arrives as the ninth, thirteenth, seventeenth, etc. subcolumn of the received frame.

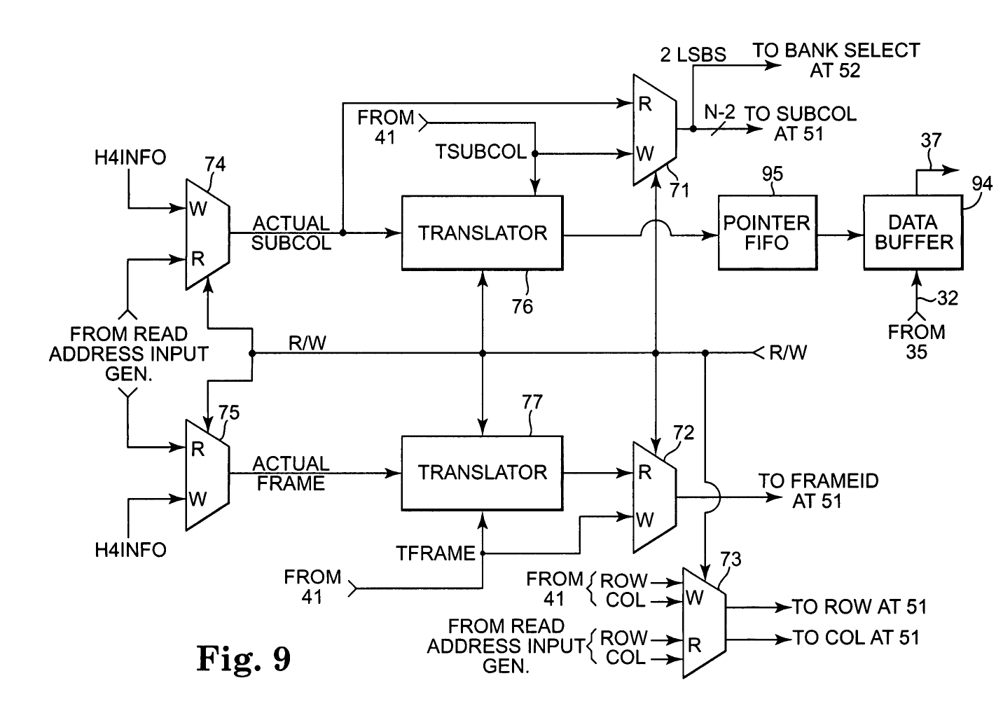

Accordingly, during memory write operations, exemplary embodiments of the present invention use the actual subcolumn identifiers produced by the conventional read address input generator to calculate the read addresses for the bytes of an entire row of a received frame. That is, the actual subcolumn identifiers produced by the read address input generator are used in FIG. 8 to calculate the memory read addresses. FIG. 9 diagrammatically illustrates exemplary embodiments of the memory interface 31 for avoiding the aforementioned type of row-crossing penalties that could possibly occur when the subcolumns of the received frame are ordered in certain specific ways such as described above.

FIG. 9 is generally similar to FIG. 7, except the output of translator 76 is coupled to a pointer FIFO 95, and the output of selector 74 is coupled to an input of selector 71, along with the tsubcol output of the write address input generator 41. In this configuration, the actual subcolumn identifiers produced by the conventional read address input generator are used in FIG. 8 to calculate the read addresses for the data bytes. Analogously to the embodiments of FIG. 7, the two LSBs of the actual subcolumn identifier are used as the bank select bits in FIG. 8. The data bytes of the currently addressed row are read in from the memory 35 and stored in a data buffer 94. In some embodiments, the data buffer is approximately 18 kilobytes wide in order to accommodate all bytes (192×87 bytes) of the currently addressed row. Also during the read operation, the sequence of tsubcol values produced by the translator 76 is input to the pointer FIFO 95. Therefore, once the currently addressed row has been read into the data buffer 94 using the actual subcolumn identifiers produced by the read address input generator, the tsubcol values stored in the pointer FIFO 95 can then be sequentially applied as pointers into the data buffer 94 in order to ensure that the 87-byte segments corresponding to each subcolumn are read out of the data buffer 94 in the proper sequence.

It will be recognized by workers in the art that the virtual concatenation receiver embodiments of FIGS. 3-9 can be readily implemented, for example, by making suitable modifications and/or additions to software, hardware, or both software and hardware in conventional virtual concatenation receivers. Although exemplary embodiments of the invention have been described above in detail, this does not limit the scope of the invention, which can be practiced in a variety of embodiments.

1. A method of processing a received virtual concatenation frame, comprising:
assigning to the frame a frame identifier that is independent of frame identification information contained within the frame;
using the frame identifier to calculate memory write addresses for respective data units contained in the frame; and
writing the data units to memory at the respectively corresponding memory write addresses.

2. The method of claim 1, including receiving a plurality of virtual concatenation frames, and assigning to each of said frames a respectively corresponding frame identifier that is independent of frame identification information contained within the frame, and assigning said frame identifiers to represent a temporal order in which the frames are received.

3. The method of claim 1, including assigning to a subcolumn within the frame a subcolumn identifier that is independent of subcolumn identification information contained within the subcolumn, and using the subcolumn identifier to calculate the memory write addresses.

4. The method of claim 3, including reading the data units from memory, said reading step including translating said frame identification information into said frame identifier and translating said subcolumn identification information into said subcolumn identifier, and using said frame identifier and said subcolumn identifier to calculate memory read addresses for the respective data units.

5. The method of claim 1, including reading the data units from memory, said reading step including translating said frame identification information into said frame identifier and using said frame identifier to calculate memory read addresses for the respective data units.

6. The method of claim 1, wherein said data units are bytes.

7. A method of processing a subcolumn in a received virtual concatenation frame, comprising:
assigning to the subcolumn a subcolumn identifier that is independent of subcolumn identification information contained within the subcolumn;
using the subcolumn identifier to calculate memory write addresses for respective data units contained in the subcolumn; and
writing the data units to memory at the respectively corresponding memory write addresses.

8. The method of claim 7, including receiving a plurality of subcolumns in a virtual concatenation frame, and assigning to each of said subcolumns a respectively corresponding subcolumn identifier that is independent of subcolumn identification information contained within the subcolumn, and assigning said subcolumn identifiers to represent a temporal order in which the subcolumns are received.

9. The method of claim 8, including receiving a plurality of virtual concatenation frames, assigning to each of said frames a respectively corresponding frame identifier that is independent of frame identification information contained within the frame, and assigning said frame identifiers to represent a temporal order in which the frames are received.

10. The method of claim 7, including reading the data units from memory, said reading step including using said subcolumn identification information to calculate memory read addresses for the respective data units, storing the data units temporarily, translating said subcolumn identification information into said subcolumn identifier, and using said subcolumn identifier to retrieve the temporarily stored data units.

11. A method of processing a received virtual concatenation frame, comprising:
producing memory write addresses for respective data units contained in a row of the frame;
writing the data units to memory at the respectively corresponding memory write addresses;
identifying first and second adjacent data units of said row which have respectively corresponding first and second memory write addresses that differ from one another by at least a predetermined amount; and
the first and second memory write addresses causing the first and second data units to be written respectively to first and second banks of memory.

12. The method of claim 11, wherein said first and second data units are respectively contained in adjacent first and second subcolumns within the frame.

13. The method of claim 12, wherein said writing step includes writing all of the data units of the first subcolumn to the first memory bank and writing all of the data units of the second subcolumn to the second memory bank.

14. The method of claim 12, wherein said producing step includes assigning to the first and second subcolumns respective subcolumn identifiers that are respectively independent of subcolumn identification information respectively contained in the first and second subcolumns, and using the first and second subcolumn identifiers to produce the first and second memory write addresses, respectively.

15. The method of claim 14, wherein said first and second subcolumn identifiers indicate respective positions occupied by the first and second subcolumns in a temporal sequence of subcolumns.

16. The method of claim 14, wherein said writing step includes the first and second subcolumn identifiers causing the first and second data units to be written respectively to said first and second banks of memory.

17. The method of claim 16, wherein said producing step includes providing respective portions of the first and second subcolumn identifiers as respective bank select portions of the first and second memory write addresses.

18. The method of claim 16, wherein said first and second subcolumn identifiers are consecutive integers.

19. The method of claim 14, wherein said identifying step includes using said first and second subcolumn identifiers to identify said first and second data units.

20. The method of claim 11, wherein said writing step includes writing the first data unit to memory and thereafter writing the second data unit to memory, and wherein said predetermined amount is sufficient to necessitate row crossing in the memory between said steps of writing said first and second data units.

21. The method of claim 11, wherein said identifying step includes counting data units in said row.

22. A virtual concatenation receiver apparatus, comprising:
an input for receiving a virtual concatenation frame;
a memory coupled to said input for storing therein data units contained in said frame;
a write address input generator for assigning to said frame a frame identifier that is independent of frame identification information contained within said frame; and
an address calculator coupled to said write address input generator for using the frame identifier to calculate memory write addresses for use in storing said data units in said memory.

23. The apparatus of claim 22, wherein said input is for receiving a plurality of virtual concatenation frames, said write address input generator for assigning to each of said frames a respectively corresponding frame identifier that is independent of frame identification information contained within the frame, and said write address input generator further for assigning said frame identifiers to represent a temporal order in which the frames are received.

24. The apparatus of claim 22, including a translator having an input for receiving said frame identification information, said translator for translating said frame identification information into said frame identifier, said address calculator coupled to said translator for using said frame identifier to calculate memory read addresses for use in reading the respective data units from said memory.

25. The apparatus of claim 22, wherein said write address input generator is further for assigning to a subcolumn within the frame a subcolumn identifier that is independent of subcolumn identification information contained within the subcolumn, said address calculator further for using said subcolumn identifier to calculate the memory write addresses.

26. The apparatus of claim 25, including a translator having an input for receiving said frame identification information and said subcolumn identification information, said translator for translating said frame identification information and said subcolumn identification information respectively into said frame identifier and said subcolumn identifier, said address calculator coupled to an output of said translator and to said translator input for using said frame identifier and said subcolumn identification information to calculate memory read addresses for use in reading the respective data units from said memory.

27. The apparatus of claim 22, wherein the virtual concatenation frame is one of a SONET virtual concatenation frame and an SDH virtual concatenation frame.

28. A virtual concatenation receiver apparatus, comprising:
an input for receiving a virtual concatenation frame;
a memory having a plurality of banks, said memory coupled to said input for storing data units contained in said frame;
an address calculator for producing memory write addresses for use in storing in said memory respective data units contained in a row of said frame;
a write address input generator for identifying first and second adjacent data units of said row that have respectively corresponding first and second memory write addresses which differ from one another by at least a predetermined amount, said address calculator coupled to said write address input generator and responsive to said identifying for producing the first and second memory write addresses such that the first and second data units are written respectively to first and second banks of said memory.

29. The apparatus of claim 28, wherein said first and second data units are respectively contained in adjacent first and second subcolumns within the frame.

30. The apparatus of claim 29, wherein said write address input generator is for assigning to the first and second subcolumns respective subcolumn identifiers that are respectively independent of subcolumn identification information respectively contained in the first and second subcolumns, said address calculator for using the first and second subcolumn identifiers to produce the first and second memory write addresses, respectively.

31. The apparatus of claim 30, wherein said first and second subcolumn identifiers indicate respective positions occupied by the first and second subcolumns in a temporal sequence of subcolumns.

32. The apparatus of claim 30, wherein said address calculator is for providing respective portions of said first and second subcolumn identifiers as respective bank select portions of said first and second memory write addresses.

33. The apparatus of claim 32, wherein said first and second subcolumn identifiers are consecutive integers.

34. The apparatus of claim 28, wherein said predetermined amount is sufficient to necessitate row crossing in said memory between a first write operation to said first memory write address and a second memory operation to said second memory write address.

35. The apparatus of claim 28, wherein said memory banks include DRAM banks.

36. A virtual concatenation receiver apparatus, comprising:
an input for receiving a subcolumn of a virtual concatenation frame;
a memory coupled to said input for storing therein data units contained within said subcolumn;
a write address input generator for assigning to said subcolumn a subcolumn identifier that is independent of subcolumn identification information contained within said subcolumn; and
an address calculator coupled to said write address input generator for using said subcolumn identifier to calculate memory write addresses for use in storing said data units in said memory.

37. The apparatus of claim 36, wherein said input is for receiving a plurality of said subcolumns, said write address input generator for assigning to each of said subcolumns a respectively corresponding subcolumn identifier that is independent of subcolumn identification information contained within the subcolumn, said write address input generator further for assigning said subcolumn identifiers to represent a temporal order in which the subcolumns are received.

38. The apparatus of claim 37, wherein said input is for receiving a plurality of virtual concatenation frames, said write address input generator for assigning to each of said frames a respectively corresponding frame identifier that is independent of frame identification information contained within the frame, said write address input generator further for assigning said frame identifiers to represent a temporal order in which the frames are received.

39. The apparatus of claim 36, including a translator having an input for receiving said subcolumn identification information, said translator for translating said subcolumn identification information into said subcolumn identifier, said address calculator coupled to said translator input for using said subcolumn identification information to calculate memory read addresses for use in reading said data units from said memory.

40. The apparatus of claim 36, wherein the virtual concatenation frame is one of a SONET virtual concatenation frame and an SDH virtual concatenation frame.

41. An apparatus for processing a received virtual concatenation frame, comprising:
means for assigning to the frame a frame identifier that is independent of frame identification information contained within the frame;
means for using the frame identifier to calculate memory write addresses for respective data units contained in the frame; and
means for writing the data units to memory at the respectively corresponding memory write addresses.

42. An apparatus for processing a subcolumn in a received virtual concatenation frame, comprising:
means for assigning to the subcolumn a subcolumn identifier that is independent of subcolumn identification information contained within the subcolumn;
means for using the subcolumn identifier to calculate memory write addresses for respective data units contained in the subcolumn; and
means for writing the data units to memory at the respectively corresponding memory write addresses.

43. An apparatus for processing a received virtual concatenation frame, comprising:
means for producing memory write addresses for respective data units contained in a row of the frame;
means for writing the data units to memory at the respectively corresponding memory write addresses;
means for identifying first and second adjacent data units of said row that have respectively corresponding first and second memory write addresses which differ from one another by at least a predetermined amount; and
means responsive to said identifying for producing the first and second memory write addresses such that the first and second data units are written respectively to first and second banks of memory.
